(19) United States
(12) Patent Application Publication
(10) Pub. No.: US 2011/0035539 A1
(43) Pub. Date: Feb. 10, 2011

(54) STORAGE DEVICE, AND MEMORY CONTROLLER

(76) Inventor: Toshiyuki HONDA, Kyoto (JP)

Correspondence Address: WENDEROTH, LIND & PONACK L.L.P., 1030 15th Street, N.W., Suite 400 East, Washington, DC, 20005-1503, US

(21) Appl. No.: 12/827,166

(22) Filed: Jun. 30, 2010

(30) Foreign Application Priority Data
Jun. 30, 2009 (JP) 2009-154962

(51) Int. Cl. G06F 12/02; G06F 12/00

(52) U.S. Cl. 711/103; 711/E12.001; 711/E12.008

(57) ABSTRACT

The memory controller of a storage device includes a scramble pattern generator, a scramble processor, a logical and physical address conversion table, a memory interface, and a controller, in which the physical page is managed by dividing to a data section and a management section. For the data section, the controller controls the scramble pattern generator to generate a scramble pattern on the basis of a logical address specific to the data section, and controls the scramble processor to scramble the data of the data section corresponding to the logical address by using the scramble pattern, and for the management section, the controller controls the scramble pattern generator to generate a scramble pattern on the basis of a physical address as the write destination of the management section, and scrambling the management data by the scramble processor by using the scramble pattern, so that data is written and reading to and from the semiconductor memory.

### BACKGROUND ART

1. Field of the Invention

The present invention relates to a storage device using a semiconductor memory such as a flash memory, and a memory controller for controlling the semiconductor memory.

2. Related Art

Recently, nonvolatile storage devices mounting NAND type flash memories which are programmable nonvolatile memories are widely used in various fields. For example, the memory card is expanding its market as a storage medium for digital camera or cellular telephone. The nonvolatile storage device is composed of semiconductor, and the nit price by bit is declining along with the microstructural trend of the process. Hence, the nonvolatile storage device has come to be used in other than the memory card as an inexpensive storage device. For example, it is used as a memory to be mounted directly on a host device, and a solid-state drive (SSD) to be used in place of the hard disk drive (HDD).

However, the microstructuralization of the process leads to decline of reliability of flash memory. For example, along with the microstructuralization of the process, the number of electrons usable for storing information is decreased, and it causes to reduce a margin for various deterioration factors such as retention, read disturb, program disturb, and so on, and defects of flash memory tend to occur easily. Various technologies have been proposed for enhancing the reliability for various deterioration factors in the flash memory. For example, JP-A-2008-198299 discloses a technology for decreasing problems of the program disturb or the read disturb, by scrambling the data to be written to the flash memory.

However, in the technique disclosed in JP-A-2008-198299, copying between pages of the flash memory is limited within word lines of a same group. JP-A-2008-198299 further discloses a technology of writing scramble seed data together with write data, as a technology for eliminating the limit. However, such technology is accompanied by another problem of how to assure the reliability of scramble seed.

### SUMMARY OF THE INVENTION

It is hence an objective of the invention to present a storage device and a memory controller capable of executing scrambling of data without causing limitation in copying between pages of flash memory, while assuring the reliability.

To achieve the objective, a storage device in a first aspect includes a semiconductor memory and a memory controller for controlling the semiconductor memory. The semiconductor memory has a plurality of physical pages, the physical page has a data section and a management section, the data section stores data having a specific logical address, and the management section stores management data, the memory controller comprises a scramble pattern generator for generating a scramble pattern, a scramble processor for scrambling by using the scramble pattern generated by the scramble pattern generator, a logical and physical address conversion table for storing a correspondence between the logical address and the physical address which is an address of an physical page of the semiconductor memory, and a controller for controlling the scramble pattern generator and the scramble processor, for the data section, the controller controls the scramble pattern generator to generate a scramble pattern on the basis of a logical address specific to the data section, and controls the scramble processor to scramble the data of the data section corresponding to the logical address by using the scramble pattern, and for the management section, the controller controls the scramble pattern generator to generate a scramble pattern on the basis of a physical address as the write destination of the management section, and controls the scramble processor to scramble the management data by using the scramble pattern, so that data is written and read to and from the semiconductor memory.

To achieve the objective, a memory controller in a second aspect of the invention writes and reads in a semiconductor memory composed of a plurality of physical pages. The memory controller has a scramble pattern generator for generating a scramble pattern, a scramble processor for scrambling by using the scramble pattern generated by the scramble pattern generator, a logical and physical address conversion table for storing a correspondence between the logical address and the physical address which is an address of an physical page of the semiconductor memory, and a controller for controlling the scramble pattern generator and the scramble processor, wherein the physical page is managed by dividing to a data section and a management section, the logical and physical address conversion table stores the correspondence between the logical address and the physical address which is the address of the physical page of the semiconductor memory, and for the data section, the controller controls the scramble pattern generator to generate a scramble pattern on the basis of a logical address specific to the data section, and controls the scramble processor to scramble the data of the data section corresponding to the logical address by using the scramble pattern, and for the management section, the controller controls the scramble pattern generator to generate a scramble pattern on the basis of a physical address as the write destination of the management section, and controls the scramble processor to scramble the management data by using the scramble pattern, so that data is written and read to and from the semiconductor memory.

In the storage device and the memory controller in the first and second aspect, the logical address of the data section or the physical address of the management section is used as a scramble seed. Hence, regardless of the storage region where the data section and the management section are stored, the scramble seed can be obtained on the basis of the logical address or the physical address in this storage region. Therefore, if data is copied from an arbitrary physical page to an arbitrary physical page, the data can be descrambled, when reading, by obtaining the scramble seed on the basis of the logical address or the physical address of the copy destination of the data. Thus, even if the data storage region (the physical address) is changed, the scramble seed can be obtained securely, so that the data can be copied from an arbitrary physical page to an arbitrary physical page. At the time of starting up the storage device, meanwhile, the logical address cannot be obtained either in the data section or in the management section. Accordingly, in this aspect, the physical address is used as the scramble seed of the management section. Therefore if the logical address is not obtained at the time of starting up the storage device and so on, the data in the management section can be descrambled and read out. Further, by using the read-out data of the management section, the logical address of the data section is obtained, and thereafter by using this logical address, by scrambling and descrambling the data section, reading or writing can be performed. Further, as the scramble seed, if the logical address of the data section or the physical address of the management section can be used, the scramble seed of the corresponding address can be securely obtained, and the reliability of the storage device for scrambling can be enhanced.

### BRIEF DESCRIPTION OF DRAWINGS

FIG. 1 is a diagram showing a configuration of a storage device in embodiment 1.

FIG. 2 is a diagram showing a configuration of physical blocks of a semiconductor memory in embodiment 1.

FIG. 3 is a diagram showing a data format of a physical page of the semiconductor memory in embodiment 1.

FIG. 4 is a flow chart of initialization of the semiconductor memory in embodiment 1.

FIG. 5 is a timing chart of writing data to the semiconductor memory in embodiment 1.

FIG. 6 is a flowchart of writing data to the semiconductor memory in embodiment 1.

FIG. 7 is a timing chart of copying data to the semiconductor memory in embodiment 1.

FIG. 8 is a flowchart of copying data to the semiconductor memory in embodiment 1.

### DETAIL DESCRIPTION OF THE INVENTION

### 1. Configuration

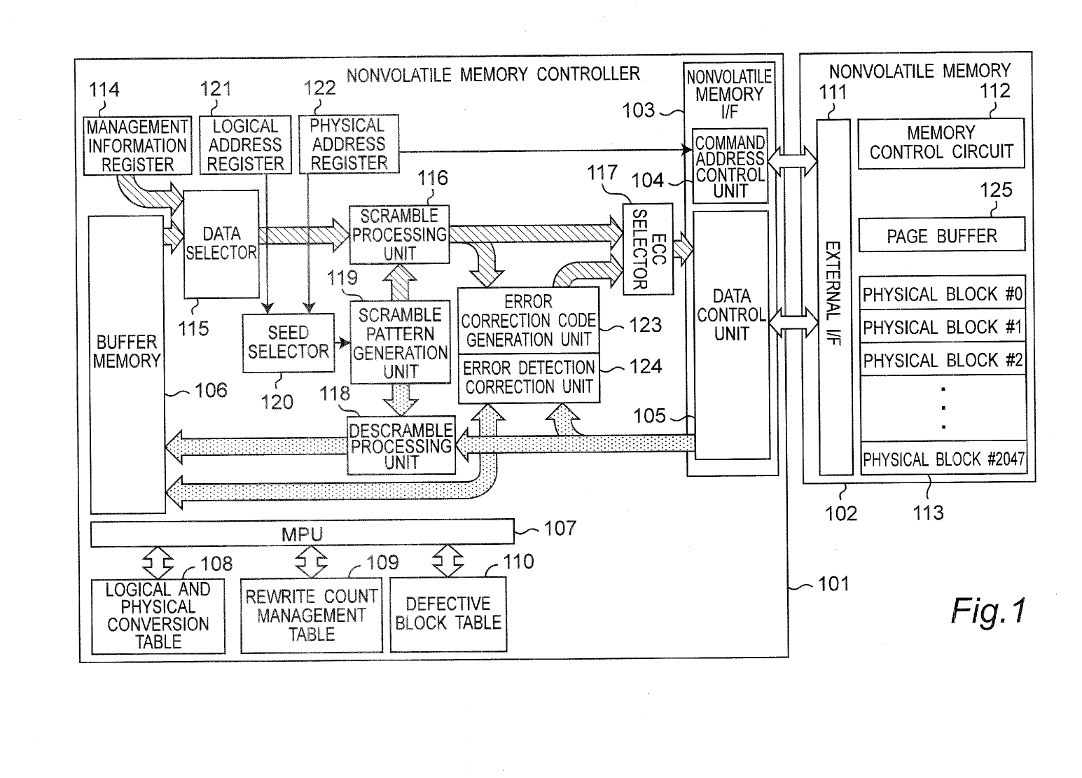

A embodiment is described below while referring to the accompanying drawings. FIG. 1 shows a configuration of a nonvolatile storage device in embodiment 1. The nonvolatile storage device includes a nonvolatile memory controller 101 which is a memory controller, and a nonvolatile memory 102. The nonvolatile memory controller 101 controls the nonvolatile memory 102, and stores data in the nonvolatile memory 102 in a nonvolatile state.

In FIG. 1, the flow of write data to the nonvolatile memory 102 is indicated by an arrow of shaded-pattern, and the flow of data read-out from the nonvolatile memory 102 is indicated by an arrow of dotted-pattern.

The nonvolatile memory controller 101 includes a nonvolatile memory interface 103 (hereinafter called “nonvolatile memory I/F 103”), a buffer memory 106, an MPU 107, a logical and physical conversion table 108, a rewrite count management table 109, a defective block table 110, a management information register 114, a data selector 115, a scramble processor 116, an ECC selector 117, a descramble processor 118, a scramble pattern generator 119, a seed selector 120, a logical address register 121, a physical address register 122, an error correction code generator 123, and an error detection correction unit 124.

The nonvolatile memory I/F 103 is an interface (hereinafter described “I/F”) for controlling the nonvolatile memory 102 in the nonvolatile memory controller 101. The nonvolatile memory I/F 103 has a command address control unit 104, and a data control unit 105. The command address control unit 104 issues a command or an address to the nonvolatile memory 102. The command includes a command for instructing of writing, a command for instructing of reading, an erase instruction command, and a process object address specifying command. The data control unit 105 controls transfer of data to be written to the nonvolatile memory 102 or the data being read out from the nonvolatile memory 102.

The buffer memory 106 temporarily stores the data to be written to the nonvolatile memory 102, and the data being read out from the nonvolatile memory 102. The data to be transferred from the buffer memory 106 into the nonvolatile memory 102 and to be written to the buffer memory 106 is expressed as sector data.

The MPU 107 is a controller for controlling the entire nonvolatile memory controller 101. The logical and physical conversion table 108, the rewrite count management table 109, and the defective block table 110 are used for controlling the nonvolatile memory 102 by the MPU 107, and stores various information. These tables 108, 109 and 110 are composed by using, for example, volatile memories.

The logical and physical conversion table 108 is a table for managing correspondence between a logical address for managing a recording position of the sector data in the nonvolatile memory controller 101 and a physical address showing an actual recording position of the sector data in the nonvolatile memory 102. By making use of this logical and physical conversion table 108, a physical page of the nonvolatile memory 102 where data corresponding to a specified logical address is stored can be known.

The rewrite count management table 109 is a table for managing the number of times of data rewrite of each physical block in the nonvolatile memory 102. The rewrite count management table 109 records the physical address and the number of times of rewrite of the physical block corresponding to this physical address.

The defective block table 110 is a table for managing the physical address of a defective block not satisfying a specified condition in write or read among physical blocks in the nonvolatile memory 102.

The management information register 114 is a register for temporarily storing the management data to be written to the nonvolatile memory 102.

The data selector 115 selects and outputs any one of the sector data from the buffer memory 106 and the management data from the management data register 114.

The scramble processor 116 scrambles the data selected and output from the data selector 115.

The error correction code generator 123 generates an error correction code on the basis of the scrambled data from the scramble processor 116.

The ECC selector 117 selects and outputs any one of the scrambled data from the scramble processor 116 and the error correction code from the error correction code generator 123.

The error detection correction unit 124 receives the data being read out from the nonvolatile memory 102 and the error correction code from the data control unit 105, detects an error, and calculates an error position. The error detection correction unit 124 also corrects an error of the data transferred to the buffer memory 106. The information used for error correction is obtained from a specified address and a specified inversion pattern. Hence, the application sequence of descrambling process executed by the descramble processor 118 and error correction process may be changed over.

The descramble processor 118 descrambles the data being read out from the nonvolatile memory 102.

The scramble pattern generator 119 generates a scramble pattern, and provides the generated scramble pattern to the scramble processor 116 and to the descramble processor 118. When scrambling normally and reversely in every bit as in the case of the scramble process disclosed in JP-A-2008-198299, the scramble pattern used in the scramble processor 116 and the scramble pattern used in the descramble processor 118 may be the same.

The logical address register 121 stores a logical address of a page for storing data.

The physical address register 122 stores a physical address of a page for storing data. The seed selector 120 selects either one address of the logical address stored in the logical address register 121 or the physical address stored in the physical address register 122 and outputs the address being selected to the scramble pattern generator 119. The seed selector 120 provides the seed value of scramble to the scramble pattern generator 119.

The nonvolatile memory 102 includes an external interface 111 (hereinafter called “external I/F 111”), a memory controller 112, a plurality of physical blocks 113, and a page buffer 125.

The external I/F 111 controls data transfer with the nonvolatile memory controller 101.

The memory controller 112 controls the parts of the nonvolatile memory 102.

The physical blocks 113 are a memory cell array. In this embodiment, there are 2048 physical blocks, from #0 to #2048. Hereinafter, the physical blocks 113 are appropriately called physical blocks #0 to #2047. These physical blocks #0 to #2047 are erase units of data in the nonvolatile memory 102.

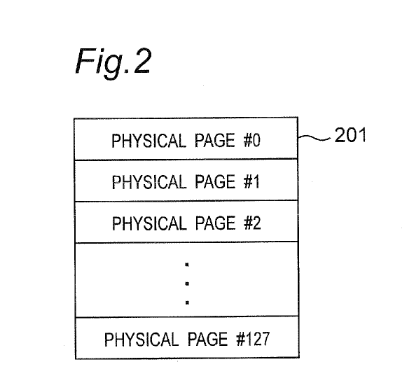

FIG. 2 is a diagram showing a configuration of the physical block 113. The physical block 113 has physical pages 201. In this embodiment, the physical block 113 has 128 physical pages 201, from #0 to #127. Hereinafter, the physical pages 201 are appropriately called physical pages #0 to #127. Therefore, the nonvolatile memory 102 has a total of 262144 (=2048 physical blocks×128 physical pages) of physical pages 201. The physical pages 201 are units of writing of data in the nonvolatile memory 102.

The page buffer 125 has a capacity equivalent to the capacity of the physical page 201. The nonvolatile memory 102, when writing data to the physical block 113, stores the data to be written temporarily in the page buffer 125 and simultaneously writes to a physical page of an object of writing. When reading out, the nonvolatile memory 102 reads out the data from the physical page 201, and stores temporarily in the page buffer 125.

The nonvolatile memory 102, when copying data between physical pages 201, stores the data in the physical page 201 of the source of copying temporarily in the page buffer 125, and then writes this data to the physical page 201 of destination of copying. When copying the data, it is possible to copy without outputting the data outside of the nonvolatile memory 102. However, in the nonvolatile memory 102, a defect may occur in storing the data. Accordingly, by reading out the data outside of the nonvolatile memory 102 and putting the error correction data to the nonvolatile memory 102, the data in the page buffer 125 may be partly corrected, and then the corrected data may be copied and written to.

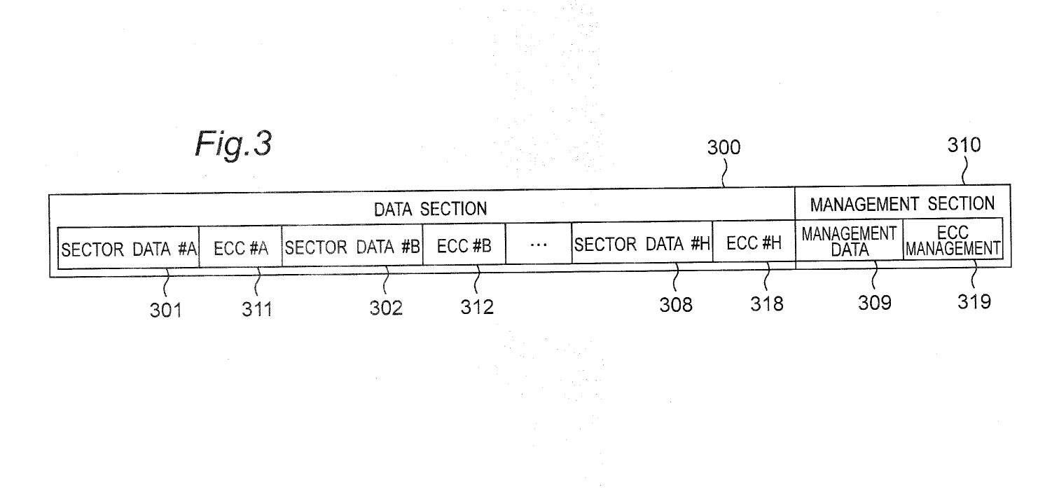

FIG. 3 is a diagram showing the data format of the data to be written to the physical pages 201 to FIG. 2 (#0 to #127).

The data to be written to the physical pages is composed of a data section 300 and a management section 310. The data section 300 is composed of a plurality of sector data 301, 302, . . . and 308, and error correction codes ECC for these sector data 311, 312, . . . and 318.

The sector data 301, 302, . . . and 308 are data transferred from the buffer memory 106 of the nonvolatile memory controller 101. The error correction codes 311, 312, . . . and 318 are generated by the error correction code generator 123 on the basis of data that is generated by scrambling the sector data 301, 302, . . . and 308 by the scramble processor 116.

The management section 310 is composed of management data 309 and ECC management data 319.

The management data 309 is data transferred from the management information register 114 of the nonvolatile memory controller 101.

The ECC management data 319 is the error correction signal generated by the error correction code generator 123 on the basis of the data of the management data 309 scrambled by the scramble processor 116.

Capacity of the data section 300 is, for example, 4 Kbytes each for sector data 301, 302, . . . and 308, and 80 Bytes each for error correction codes 311, 312, . . . and 318 to be applied to the sector data 301, 302, . . . and 308. In one sector data and one error correction code, the total is about 4 Kbytes+80 Bytes. Capacity of the management section 310 is a total of about 20 Bytes, including the management data 309 and the ECC management data (error correction code) 319 to be applied to the management data 309.

### 2. Operation

The operation of the nonvolatile storage device of the embodiment is described.

### 2.1 Operation Upon Starting

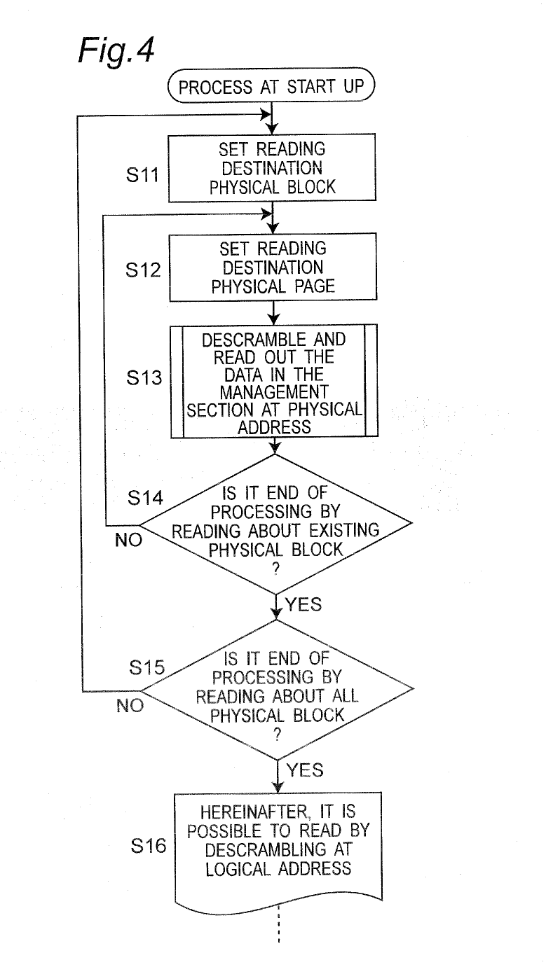

Referring to the flowchart in FIG. 4, the starting operation of the nonvolatile storage device is explained. Operation upon starting is executed under control of the nonvolatile memory controller 101.

First, the nonvolatile memory controller 101 sets a physical block of a source of reading (S11).

Next, the nonvolatile memory controller 101 sets a physical page of the source of reading (S12).

Further, the nonvolatile memory controller 101 reads out the data in the management section 310 by descrambling at a physical address showing a data recording position of the management section 310. From the management data 309 in the management section 310, a logical address showing a data recording position of the sector data section 300 is acquired (S13). Using relation between the obtained physical address and the logical address, data of logical and physical conversion table 108 is created.

Consequently, the nonvolatile memory controller 101 judges if the process of step S13 has been executed or not on all physical pages in the physical block set at step S11 (S14). If the process for all physical pages has not been completed, returning to step S12, other physical page is set, and thereafter the same process is executed. On the other hand, when the process for all physical pages has been completed, the process goes to step S15.

The nonvolatile memory controller 101 judges if the process of step S13 has been executed or not on all physical blocks (S15). If the process for all physical blocks has not been completed, returning to step S11, other physical block is set, and thereafter the same process is executed. On the other hand, when the process for all physical pages has been completed, the process goes to step S16.

After step S16, by utilizing the management data 309 in the management section 310 being read out in this manner, the sector data can be read out by descrambling at the logical address at the source of reading of the data. Although it is explained herein that all pages of all physical blocks are read out, but when the data in the logical and physical conversion table 108 is stored in the nonvolatile memory 102, it is enough to search only the physical block in which the data in the logical and physical conversion table 108 is stored. In this case, the data in the logical and physical conversion table is also assigned with a specific logical address.

### 2.2 Writing Operation to Nonvolatile Memory

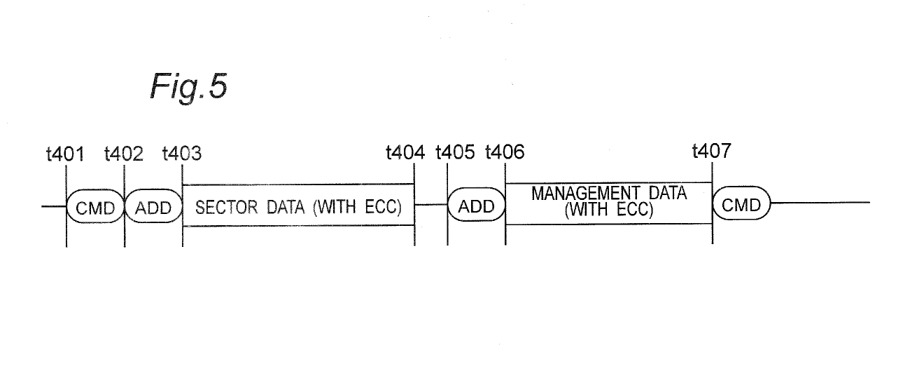

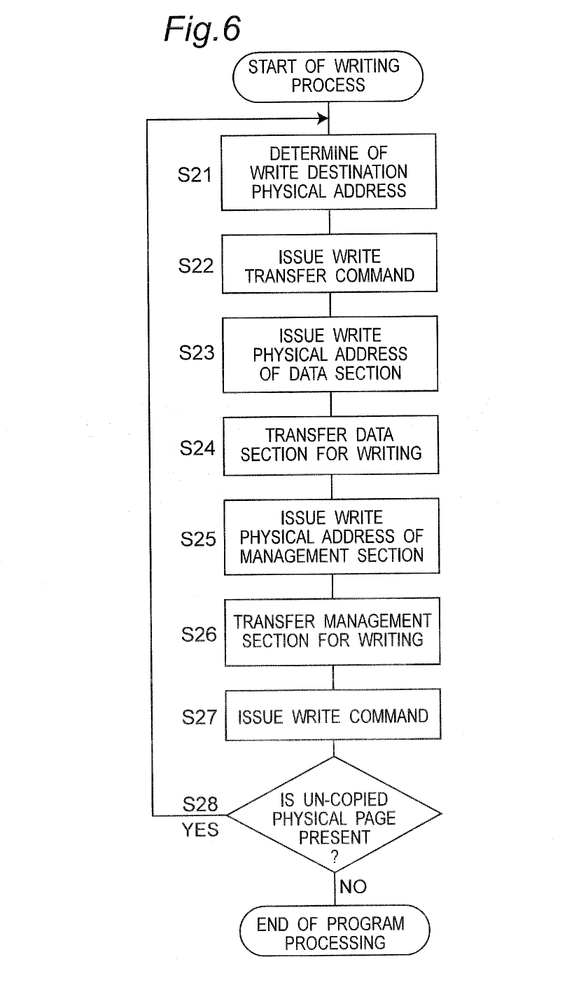

FIG. 5 is a diagram showing a timing chart when writing data of one physical page in the nonvolatile memory 102 by the nonvolatile memory controller 101. FIG. 6 is a flowchart of writing operation to the nonvolatile memory 102. Referring to FIG. 5 and FIG. 6, the operation of the nonvolatile memory controller 101 when writing data to the nonvolatile memory 102 is described. Herein, operation in the nonvolatile memory 101 is comprehensively executed under control of the MPU 107. In the following explanations, reference codes of the sector data and management data are appropriately omitted.

First, the nonvolatile memory controller 101 determines a physical address of a destination of writing (S21).

At time t401, the command address control unit 104 issues a command directing start of writing to the nonvolatile memory 102 (S22). At time t402, the command address control unit 104 issues a physical address of an object of writing in the nonvolatile memory 102, to the nonvolatile memory 102 (S23). The process of command issue and address issue can be executed by a few clocks.

At time t403, transfer of the data in the data section 300 (the sector data and error correction code ECC) is started (S24). Specifically, when transferring the sector data, the sector data output from the buffer memory 106 is selected by the data selector 115, and scrambled by the scramble processor 116, selected by the ECC selector 117, and transferred from the data control unit 105 to the nonvolatile memory 102. By contrast, when transferring the error correction code, the output of the scramble processor 116 is calculated by the error correction code generator 123 at the time of transfer of sector data and an error correction code is generated, this generated error correction code is selected by the ECC selector 117, and is transferred from the data control unit 105 to the nonvolatile memory 102. Transfer of sector data and transfer of error correction code are executed alternately. At time t404, transfer of the data in the data section 300 is completed. In this transfer of the sector data, the seed selector 120 provides the logical address stored in the logical address register 121 to the scramble processor 116 as a seed value. The scramble pattern generator 119 generates a scramble pattern on the basis of this logical address, that is, the logical address in the storage region of the destination of writing, and provides to the scramble processor 116. As a result, the sector data is scrambled by using the logical address of the destination of writing as the seed value.

At time t405, the command address control unit 104 issues an address of the beginning of the management data to the nonvolatile memory 102 (S25).

At time t406, transfer of the data in the management section 310 (the management data and error correction code ECC) is started (S26). Specifically, when transferring the management data, the management data stored in the management information register 114 is selected by the data selector 115, a scramble pattern is generated by utilizing the physical address of the destination of writing, and the management data is scrambled by the scramble processor 116 by using this scramble pattern, is selected by the ECC selector 117, and is transferred from the data control unit 105 to the nonvolatile memory 102. By contrast, when transferring the error correction code, the output of the scramble processor 116 is calculated by the error correction code generator 123 at the time of transfer of the management data, an error correction code is generated, and this generated error correction code is selected by the ECC selector 117 and is transferred from the data control unit 105 to the nonvolatile memory 102. In transferring the management data, the seed selector 120 provides the physical address stored in the physical address register 122 to the scramble processor 116 as a seed value. The scramble pattern generator 119 generates a scramble pattern on the basis of this physical address, and provides to the scramble processor 116. As a result, the management data is scrambled by using the physical address of the destination of writing as the seed value.

At time t407, transfer of the data in the management section 310 is completed. The command address control unit 104 issues a command for executing writing to the nonvolatile memory 102 (S27). Receiving this write execution command, the nonvolatile memory 102 writes the data stored in the page buffer 125 to the specified physical page.

When writing to the physical page, the data in the management section 310 is not scrambled by using the logical address as the seed value, of which reason is as follows. That is, in a nonvolatile storage device using the nonvolatile memory 102, for writing and reading, the nonvolatile memory controller 101 must always have the information about a writing state of each physical block 113 included in the nonvolatile memory 102. For this purpose, the nonvolatile memory controller 101 always accesses the management section 310 of the nonvolatile memory 102 when turning on the power source, and acquires the writing state of each physical block 201. However, when turning on the power source, the nonvolatile memory controller 101 cannot obtain a logical address of the management section 310. Instead, by utilizing the physical address, the management data stored in the management section 310 is acquired. Accordingly, in the management section 310, the physical address that can be determined at the time of reading is utilized as the seed value for scrambling.

It is then judged if an un-copied physical page is present or not (S28). If an un-copied physical page is not present, the writing transfer process is completed, and if present, the same process is repeated by returning to step S21.

In this embodiment, by using the physical address as the seed value to execute scrambling of the management section 310, the writing state can be recognized in each physical page.

### 2.3 Data Copying Operation in Nonvolatile Memory

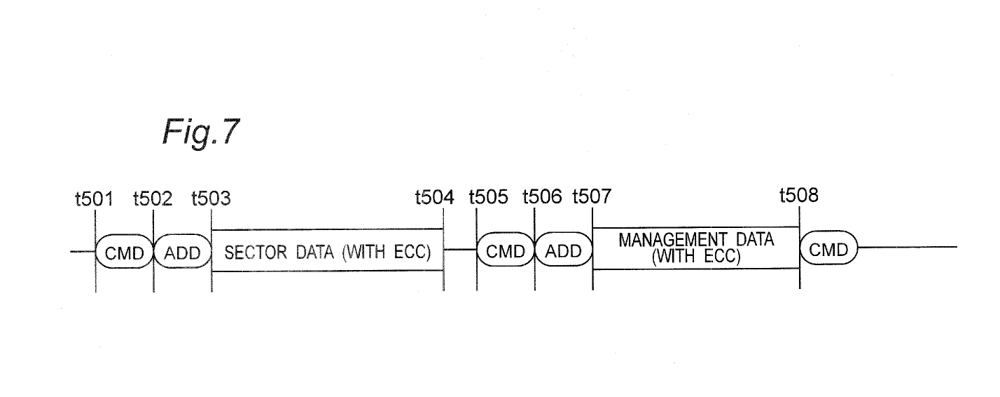

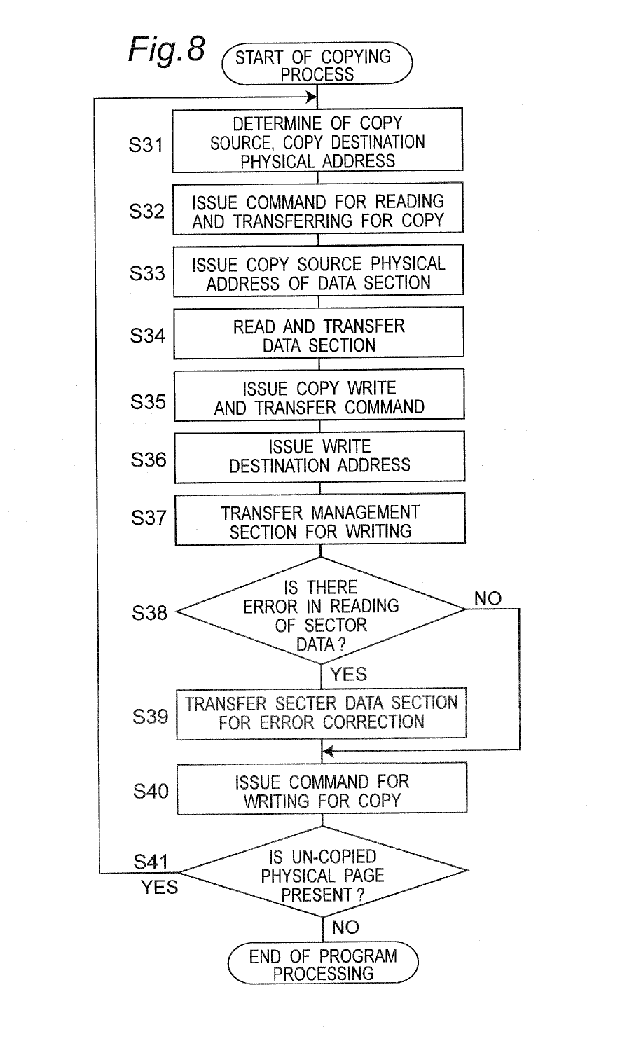

FIG. 7 is a timing chart when copying data of one physical page written in the nonvolatile memory 102 to another physical page (copy-back) in the nonvolatile storage device in FIG. 1. FIG. 8 is a flowchart when copying the data of one physical page written in the nonvolatile memory 102 to another physical page. Referring to FIG. 7 and FIG. 8, the operation of the nonvolatile memory controller 101 when copying the data to the nonvolatile memory 102 is explained.

First, the nonvolatile memory controller 101 determines a physical address of the source of copying and the destination of copying (S31).

At time t501, the command address control unit 104 of the nonvolatile memory controller 101 issues a command (CMD) directing start of reading for copy to the nonvolatile memory 102 (S32).

At time t502, the command address control unit 104 issues a physical address of a physical page of the nonvolatile memory 102 for reading for copy to the nonvolatile memory 102 (S33).

From time t503, the nonvolatile controller 101 starts reading and transferring of sector data and error correction code in the data section 300 (S34). This data transfer is conducted by reading and transferring of sector data and error correction code stored in the nonvolatile memory 102 by the data control unit 105. The data being read out from the data control unit 105 is descrambled by the descramble processor 118 on the basis of the physical address of the source of copying, is transferred to the buffer memory 106, and is simultaneously transferred to the error detection correction circuit 124.

At time t504, reading and transferring of the data in the data section 300 is completed. Thereafter, data is not read out for checking presence or absence of bit error in the data in the management section 310. This is because the data in the management section 310 has been written after being scrambled by using the physical address of the destination of copying as the seed value, and all data is re-written at the time of data copying.

At time t505, the command address control unit 104 issues a command directing start of writing for copy to the nonvolatile memory 102 (S35).

At time t506, the command address control unit 104 issues a physical address of a physical page of the nonvolatile memory 102 for writing for copy to the nonvolatile memory 102 (S36).

The physical address to be designated herein is not limited by the physical address designated at time t502. As the seed value for scrambling the sector data, since the logical address of the destination of copying is used, even if data is copied from an arbitrary physical page to an arbitrary physical page, the sector data can be read out by descrambling correctly by using the logical address at the destination of copying when reading out the data at the destination of copying.

At time t507, the nonvolatile memory controller 101 starts transfer of management data and error correction code (ECC) corresponding to the management section 310 (S37). This data transfer is performed as the same as with the transfer at time t406 in FIG. 4. The scramble pattern is generated as a seed value, using the physical address of the physical address register 122.

At time t508, data transfer of the management section 310 is completed.

Next, the nonvolatile memory controller 101 checks if an error is involved or not when reading out the sector data (S38).

If error is not found at step S38, the command address control unit 104 issues a command for executing of writing for copy to the nonvolatile memory 102 (S40). Receiving this execution command for writing for copy, the nonvolatile memory 102 write the data stored in the page buffer 125 to the designated physical page.

The nonvolatile memory controller 101 judges if an un-copied physical page is present or not (S41). If an un-copied physical page is not present, the copying process is completed, and if present, the same process is repeated by returning to step S31.

By contrast, if an error is found at step S38, the nonvolatile memory controller 101 transfers an error correction of sector data (S39). Then the process of steps S40, S41 is executed.

### 3. Summary

The nonvolatile storage device of the embodiment includes a nonvolatile memory 102 and a nonvolatile memory controller 101 for controlling the nonvolatile memory 102. The nonvolatile memory 102 has a plurality of physical pages 201, the physical page 201 has a data section 300 and a management section 310, the data section 300 stores sector data 301 to 308 having specific logical addresses, and the management section 310 stores management data 309. The nonvolatile memory controller 101 has a scramble pattern generator 119 for generating a scramble pattern, a scramble processor 116 for scrambling by using the scramble pattern generated by the scramble pattern generator 119, a logical and physical address conversion table 108 for storing a correspondence between the logical address and the physical address which is the address of the physical page 201 of the nonvolatile memory 102, and an MPU 107 for controlling the scramble pattern generator 119 and the scramble processor 116. For the data section 300, the MPU 107 controls the scramble pattern generator 119 to generate a scramble pattern on the basis of the logical address specific to the data section 300, and controls the scramble processor 118 to scramble the sector data corresponding to the logical address by using this scramble pattern generated by the scramble pattern generator 119. For the management section 300, the MPU 107 controls the management section 310 to generate a scramble pattern on the basis of the physical address as the write destination or the read source of the management section 310, and controls the scramble processor 116 to scramble the management data 309 by using the scramble pattern generated by the scramble pattern generator 119, so that data is written and read to and from the nonvolatile memory 102.

Thus, in the storage device of the embodiment, the logical address or the physical address of the destination of writing or the source of reading is used as scramble seed. Hence, regardless of the storage region where the data section is stored, the scramble seed can be obtained on the basis of the logical address in this storage region. Therefore, if data is copied from an arbitrary physical page to an arbitrary physical page, the data can be descrambled, when reading, by obtaining the scramble seed on the basis of the logical address or the physical address at the destination of copying of the data. Thus, even if the data storage region (the physical address) is changed, the scramble seed can be obtained securely, so that the data can be copied from an arbitrary physical page to an arbitrary physical page. In addition, since the logical address corresponds to the data in the data section, it is not necessary to change the scramble seed when copying data from an arbitrary physical page to an arbitrary physical page. Therefore, the data in the page buffer 125 in which data is stored at the time of reading can be directly written as the data in the data section. That is, it is not necessary to repeat the scrambling process, and it is not needed to transfer the data in the data section from the nonvolatile memory controller 101 to the nonvolatile memory 102. Accordingly, high-speed data copying by using the page buffer 125 of the nonvolatile memory 102 is realized. At the time of starting up the storage device, meanwhile, the logical address cannot be obtained either in the data section 300 or in the management section 310. Accordingly, in the embodiment, the physical address is used as the scramble seed of the management section 310. Therefore, even if the logical address is not obtained at the time of starting up the storage device, and so on, the data in the management section 310 can be descrambled and read out. Further, by using the read-out management data 309 of the management section 310, the logical address of the sector data in the data section 300 is obtained, and thereafter by using this logical address, by scrambling and descrambling the data section 300, reading or writing may be realized. As the scramble seed, moreover, if the logical address of the data section or the physical address of the management section can be used, the scramble seed of the corresponding address can be securely obtained, and it is not necessary to change the scramble seed of the data in the data section, and data can be copied at high speed between arbitrary physical pages, so that the reliability of the storage device can be enhanced by scrambling.

### INDUSTRIAL APPLICABILITY

The present invention may be widely applied in the storage device using a semiconductor memory, and a memory controller for controlling the memory.

1-9. (canceled)

10. A storage device comprising a semiconductor memory, and a memory controller for controlling the semiconductor memory, wherein
the semiconductor memory has a plurality of physical pages,
the physical page has a data section and a management section,
the data section stores data having a specific logical address, and the management section stores management data,
the memory controller comprises a scramble pattern generator for generating a scramble pattern, a scramble processor for scrambling by using the scramble pattern generated by the scramble pattern generator, a logical and physical address conversion table for storing a correspondence between the logical address and the physical address which is an address of a physical page of the semiconductor memory, and a controller for controlling the scramble pattern generator and the scramble processor,
for the data section, the controller controls the scramble pattern generator to generate a scramble pattern on the basis of a logical address specific to the data section, and controls the scramble processor to scramble the data of the data section corresponding to the logical address by using the scramble pattern, and
for the management section, the controller controls the scramble pattern generator to generate a scramble pattern on the basis of a physical address as the write destination of the management section, and controls the scramble processor to scramble the management data by using the scramble pattern, so that data is written and read to and from the semiconductor memory.

11. The storage device according to claim 10, wherein
the semiconductor memory is a nonvolatile memory, and
the physical page is a unit of writing to the nonvolatile memory.

12. The storage device according to claim 11, wherein
the nonvolatile memory is a flash memory of NAND type.

13. The storage device according to claim 12, wherein
the flash memory of NAND type is formed of a multivalued memory cell.

14. The storage device according to claim 10, which is a removable memory card.

15. A memory controller for writing and reading in a semiconductor memory having a plurality of physical pages, comprising:
a scramble pattern generator for generating a scramble pattern, a scramble processor for scrambling by using the scramble pattern generated by the scramble pattern generator, a logical and physical address conversion table for storing a correspondence between the logical address and the physical address which is an address of a physical page of the semiconductor memory, and a controller for controlling the scramble pattern generator and the scramble processor, wherein
the physical page is managed by dividing to a data section and a management section,
the data section stores data having a specific logical address, and the management section stores management data, and
for the data section, the controller controls the scramble pattern generator to generate a scramble pattern on the basis of a logical address specific to the data section, and controls the scramble processor to scramble the data of the data section corresponding to the logical address by using the scramble pattern, and
for the management section, the controller controls the scramble pattern generator to generate a scramble pattern on the basis of a physical address as the write destination of the management section, and controls the scramble processor to scramble the management data by using the scramble pattern, so that data is written and read to and from the semiconductor memory.

16. The memory controller according to claim 15, wherein
the semiconductor memory is a nonvolatile memory, and
the physical page is a unit of writing to the nonvolatile memory.

17. The memory controller according to claim 16, wherein
the nonvolatile memory is a flash memory of NAND type.

18. The memory controller according to claim 17, wherein
the flash memory of NAND type is formed of a multivalued memory cell.
